(19) United States
(12) Patent Application Publication
(10) Pub. No.: US 2010/0281424 A1
(43) Pub. Date: Nov. 4, 2010

(54) System and Method for Virtual Kiosk Stored Photo-image Reproduction

(76) Inventors: Dimitry Vaysburg, Livermore, CA (US); Vinay Ravuri, Santa Clara, CA (US); Prodyut Hazarika, Mountain View, CA (US); Loc Ho, San Jose, CA (US); Tushar Tyagi, Sunnyvale, CA (US); Paramesh Gopi, Cupertino, CA (US); Dmitriy Shtalenkov, Foster City, CA (US); Vidhyananth Venkatasamy, Sunnyvale, CA (US); Gilles Garcia, Palo Alto, CA (US); Fushen Chen, San Jose, CA (US); Victor Gallardo, Chula Vista, CA (US)

Correspondence Address: LAW OFFICE OF GERALD MALISZEWSKI, P.O. BOX 270829, SAN DIEGO, CA, 92198-2829, US

(21) Appl. No.: 12/432,559

(22) Filed: Apr. 29, 2009

Related U.S. Application Data
(63) Continuation-in-part of application No. 12/431,914, filed on Apr. 29, 2009.

(51) Int. Cl. G06F 3/048; G06F 17/30

(52) U.S. Cl. 715/810; 707/E17.032

(57) ABSTRACT

A virtual kiosk system and method are provided for stored photo-image reproduction. A photo-image discovery device, having no dedicated display, scans communication interfaces for photo-capable devices, and determines if detected photo-capable devices have stored electronically formatted photo-images. The photo-images are acquired into the photo-image discovery device, and the acquired photo-images are uploaded to a network-connected storage site. Subsequently, the photo discovery device may be interfaced to a display monitor. A menu of photo-image user prompt options is depicted on the display monitor, originating from the photo discovery device. The storage site is accessed from the photo discovery device in response to a first user prompt. In response to a second user prompt, a stored photo-image is selected. In one aspect a delivery option for the selected photo-image is selected in response to an additional user prompt.

### RELATED APPLICATIONS

This application is a Continuation-in-Part of a pending application entitled, SYSTEM AND METHOD FOR PHOTO-IMAGE DISCOVERY AND STORAGE, invented by Vaysburg et al., Ser. No. 12/431,914, filed Apr. 29, 2009, attorney docket no. applied_{—}330, which is incorporated herein by reference.

### BACKGROUND OF THE INVENTION

1. Field of the Invention

This invention generally relates to electronic image storage and more particularly to a virtual kiosk system and method for photo-image management, transformation, and delivery options.

2. Description of the Related Art

Conventional technology permits a user to connect their camera or memory card to a personal computer (PC), open a software application in the PC, and upload images for local storage. Once the images are stored, the user may select images for local printing, organize folders, or create a CD. Further, the images may be uploaded to a network-connected storage site vendor, such as Costco. Once the images are uploaded, the user may select images for printing, and have the printed pictures prepared for pickup or delivery. Otherwise, the user can have the images archived.

Unfortunately, these operations are cumbersome and require extensive human interaction. Further, a minimal amount of technical acumen is required to perform these operations, and if the user is technophobic, the images may remain in the camera until they are lost, erased, of overwritten.

Eye-Fi™ is a wireless memory card that automatically uploads any images on the card, via a WiFi (IEEE 802.11) link, to a user's PC for local storage, or to a network-connected storage site. Unfortunately, the images remain on the memory card until the user comes within range of a WiFi access point (AP). The user cannot upload their images via a public AP unless the card has been previously preconfigured. Such an operation would require the use of a PC and a related software application. Due to the relatively long time it takes to upload a single image, the system is only practical for user who has a personal (home) WiFi AP. Further, while the automatic upload feature is a convenience, the user has lost all ability to edit and organize the images leaving the camera, and it is not necessarily easy to organize the images once they have been uploaded. Finally, the user is unaware of which, if any, images have been successfully uploaded until they inventory their storage.

Conventionally, an end user who wants to print, order prints of their pictures, create albums, or personalize their photos, must use either a PC-driven software tool, or go to the store photo kiosk. The first option requires a working knowledge of PCs and a high-speed Internet connection. Alternately, if a user goes to the store, they must bring their SD card or USB key to select the pictures. This selection process can be lengthy and may require assistance from store personnel.

It would be advantageous if images, previously uplinked to a net work-connected storage site, could be managed without a PC or a trip to the store.

### SUMMARY OF THE INVENTION

A photo discovery system and method are disclosed, herein that are capable of acquiring images from a variety of different sources, such as a digital camera, camcorder, 3G phone, cell phone, or personal computer (PC), and upload them into an Internet-connected storage/processing service. Once stored, the same photo discovery device can be used print, archive, or otherwise manage the images as a virtual kiosk, without the use of a personal computer (PC).

Accordingly, a virtual kiosk method is provided for stored photo-image reproduction. A photo-image discovery device, having no dedicated display, scans communication interlaces for photo-capable devices, and determines if detected photo-capable devices have stored electronically formatted photo-images. The photo-images are acquired into the photo-image discovery device, and the acquired, photo-images are uploaded to a network-connected storage site. Subsequently, the photo discovery device may be interfaced to a display monitor. A menu of photo-image user prompt options is depicted on the display monitor, originating from the photo discovery device. The storage site is accessed from the photo discovery device in response to a first user prompt. In response to a second user prompt, a stored photo-image is selected. In one aspect a delivery option for the selected photo-image is selected in response to an additional user prompt.

Additional details of the above-described method and a virtual photo-image reproduction kiosk are provided below.

### BRIEF DESCRIPTION OF THE DRAWINGS

FIG. 1 is a schematic block diagram of a photo-image discovery device.

FIG. 2 is a diagram depicting a first exemplary image organization transaction.

FIG. 3 is a diagram depicting a second exemplary image organization transaction.

FIGS. 4A and 4B depict two exemplary processes for configuring the photo-image discovery device of FIG. 1.

FIG. 5 is a schematic block diagram of a virtual photo-image reproduction kiosk.

FIG. 6 is a diagram depicting the photo-image discovery device from a functional perspective.

FIG. 7 is a flowchart illustrating a virtual kiosk method for stored photo-image reproduction.

### DETAILED DESCRIPTION

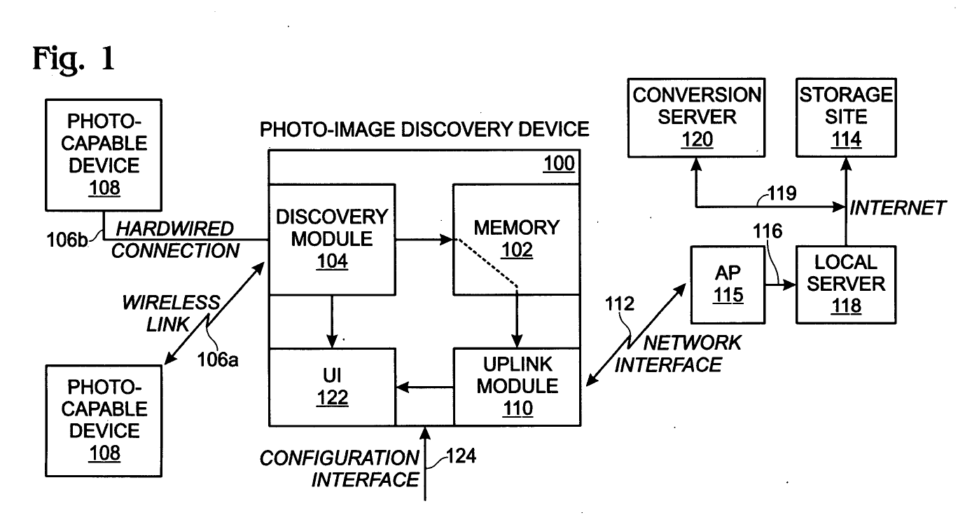

FIG. 1 is a schematic block diagram of a photo-image discovery device. The photo-image discovery device 100 comprises a memory 102 and a discovery module 104 having a scanning interface on line 108 for detecting photo-capable devices. In one aspect, the discovery j module scanning interface concurrently scans wireless and hardwired connector interfaces. The wireless interface is represented by reference designator 106a and the hardwire connector interface by reference designator 106b. For simplicity, only a single wireless and single hardwired interface are shown. However, it should be understood that multiple such interfaces may be required for different protocols, frequencies, and connector types.

Some examples of the wireless interface 108a include Bluetooth, wireless USB, and IEEE 802.11 (WiFi) interfaces. However, the device 100 is not limited to just these examples. Some examples of hardwire connector interface 106b include Universal Serial Bus (USB) and SD memory card interfaces. Some examples of photo-image file types include JPEG, GIF, EXIF, native format, BMP, CR2, RAW, and MPEG, Again, the system, is not limited to just these exemplary file types and interfaces.

The discovery module 104 determines if detected photo-capable devices 108 have stored electronically formatted photo-images, and if so, acquires the photo-images into the memory 102. If the detected photo-images have been previously acquired into the memory, the photo-images are not reacquired. Some examples of photo-capable devices include a cellular telephone, 3G cell phone, a personal computer (PC), controlled automation device, digital video disk (DVD) device, camera-enabled wireless device, video-enabled wireless device, television, digital video recorder (DVR), secure digital (SD) memory card, digital camera, and game console. Some examples of a controlled automation device include home camera security system and a remotely programmable DVR. In one aspect, the discovery module 104 acquires photo-images from only preconfigured photo-capable devices 108. That is, the discovery module 104 will only acquire photo-images from a limited group of devices with which it has been given permission to act. In this manner, the photo-image discovery device will not “accidentally” acquire images from unauthorized sources. The photo-image discovery device enters photo-capable device configuration commands via a built-in user interface (UI) 122, or via a configuration interface 124, as explained in more detail below.

An uplink module 110 has a network interface on line 112. The uplink module 110 automatically uploads the photo-images in the memory 102 to a network-connected storage site 114. Although only a single storage site is shown for simplicity, it should be understood that the photo-image discovery device is able to communicate with any number of storage sites. The photo-image discovery device may send the same photo-images to more than one storage site. In one aspect, the uplink module 110 uploads photo-images via a WiFi interface to a network-connected server 114. As shown, a WiFi access point (AP) 115 wirelessly receives Information from the photo-image discovery device, transfers the information via a landline 118 to a local server 118, which then uses an Internet protocol to transfer the information to storage server 114 via line 119. However, it would be possible to upload photo-images using other nodes or other protocols to reach the storage site.

Typically, the discovery module 104 acquires and stores the photo-images into memory in the first format, and the uplink module 110 uploads the acquired photo-image in the first format. In one aspect, the discovery module uploads photo-images in a first format (e.g., JPEG) and converts the photo-images to a second format (e.g., GIF). Then, the uplink module 110 uploads photo-images in the second format to the storage site 114. Alternately, the discovery module 104 acquires photo-images in a first format and the uplink module 110 uploads the photo-Images to a network-connected conversion device 120 for conversion into a second format. In one aspect, the converted photo-images are returned to the photo-discovery device 100 for uplink to the storage site 114. Alternately, the conversion device transfers the converted photo-images to the storage site directly, via line 119.

In a different aspect, the photo-images may be uploaded and downloaded in the same file format, but can have image attributes changed such as the resolution, compression ratio, red-eye removal. The attributes changed would be dependent upon, the attribute parameters associated with the storage device or destination.

In another aspect, the uplink module 110 has an Interface for receiving storage site selection commands and transfers the photo-images to at least one selected storage site. The commands may be entered via a built-in user interface (UI) 122, or communicated via a configuration interface 124, as explained in more detail below. The uplink module 110 may determine a photo-image format associated with the selected storage and direct the discovery module or conversion site to convert acquired photo-Images to the format associated with the selected storage device.

In one aspect, the UI 122 receives a signal from the uplink module 110 subsequent to uploading the photo-images to the storage site, indicating that the photo-images have been successfully uploaded. In turn, the UI 122 supplies an indication to the user of a successful upload. Likewise, in the event of a failure to upload the photo-Images to the storage site, the uplink module 110 may supply a signal to the UI, and the UI supply a prompt to the user, indicating that the photo-images have not been successfully uploaded.

For example, the UI may be a light emitting diode (LED), or a set of LEDs, where LED groups, LED flash patterns, or LED colors signify different events. In another aspect, the UI 122 may incorporate a visual display, such as a liquid crystal display (LCD), Further, the UI 122 may incorporate buttons, switches, a keypad, or a mouse to accept user commands. In one aspect, the discovery module 104 automatically acquires photo-images from devices. However, in another aspect the discovery module only acquires photo-images in response to a UI prompt. That is, the UI 122 indicates that photo-images are available for acquisition, and the user must affirmatively authorize acquisition using a UI button, switch, or the like.

In a similar manner, if the discovery module 104 fails to acquire the photo-Images into the memory, it supplies a signal to the UI indicating that the photo-images have not been successfully acquired. In turn, the UI 122 supplies some kind of indicator to the user. Likewise, if the discovery module 104 successfully acquires the photo-images into the memory, it supplies a signal to the UI 122, and the UI 122 supplies an appropriate indicator to the user.

The discovery module 104 may also organize acquired photo-Images into folders using criteria such, as user, the photo-image discovery device ID, file types, or the photo-capable device originating the photo-images, to name a few examples. The folders may be established, in memory 102. Alternately, instructions may accompany the uplinked photo-images, so that folders are created at the storage site 114, and the photo-Images stored in the corresponding folder types.

It is difficult for a user to remember the circumstances associated with each of their photos. This problem is compounded when the user is faced with the daunting task of remembering, sorting, and organizing photos on a camera memory card filled with hundreds of pictures. Conventional processes that simply move the photos from one storage site (i.e. the memory card) to a second storage site (i.e. a PC or network-connected storage site) do not adequately address this problem.

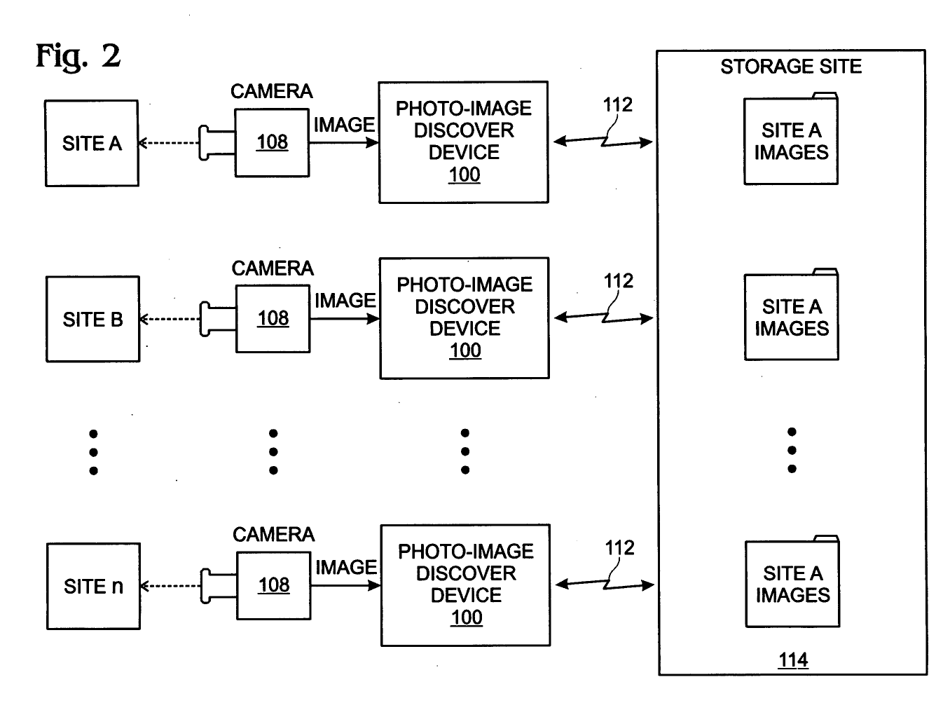

FIG. 2 is a diagram depicting a first exemplary image

organization transaction. The photo-image discovery device disclosed herein advantageously acts as an intermediary between images stored on a camera device and storage, giving the user the opportunity to organize images. Some of this organization is performed using the mechanisms already described above. For example, the photo-image discovery device may be preconfigured to separate the images associated with each acquisition/upload operation into a separate folder. If the user is a tourist in Rome, they may choose to manually acquire/upload images after each attraction (sites A through n) they visit. In that manner, the photos associated with each attraction are automatically organized into separate folders at the storage site.

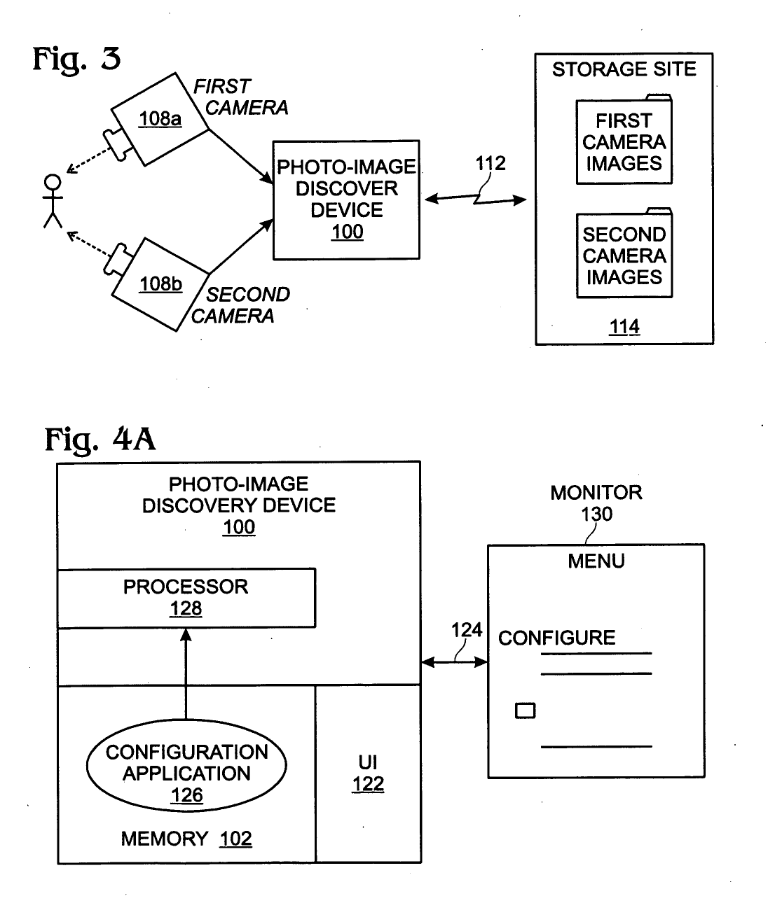

FIG. 3 is a diagram depicting a second exemplary image organization transaction. As another example, the photo-image discovery device may be configured to acquire images from, two cameras. If there is a different user associated with each camera, the photo-image discovery device is automatically insuring that the acquired/uplinked photo-images are being saved in different folders differentiated by user (camera).

More complicated organizational schemes may be pre-configured or implemented on-the-fly if the UI 122 is sophisticated enough. Alternately, if the UI 122 is simple (i.e. a set of LEDs), the configuration, interface 124 may be used to enter commands.

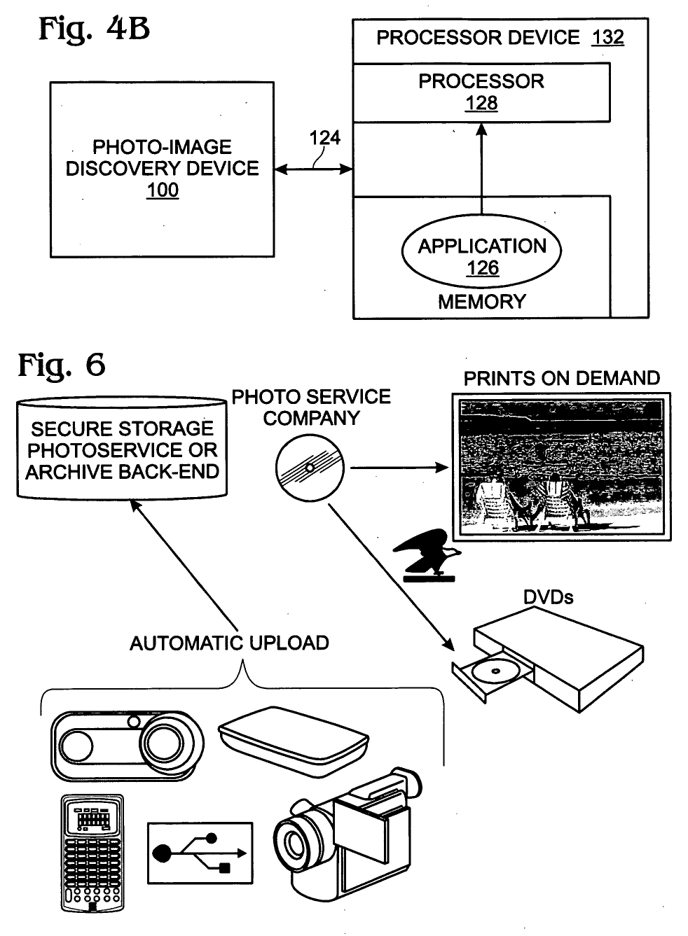

FIGS. 4A and 4B depict two exemplary processes for configuring the photo-image discovery device of FIG. 1. Generally, as shown in FIG. 4A, the configuration interface is wirelessly or hardwire connected to a simple monitor 130, such as a television screen. A configuration software application 126 is stored in memory 102 and enabled as processor instructions. The Instructions are executed by processor 128. By executing instructions in the configuration application, the photo-image discovery device is able to generate a menu of instruction prompts and menu options on monitor 130. The user is able to navigate through the menu of prompts and options using the UI 122 (e.g., buttons or keypad). In one aspect, the photo-Image discovery device is able to make selections as a wireless point-and-click device.

In another variation (FIG. 4B), the configuration software application 126 resides in a microprocessor device 132 such as a PC or cell phone. Changes and modifications to the photo-image discovery device are made by running the configuration application on the PC. Then, the changes can be loaded into the photo-image discovery device via the configuration interface 124.

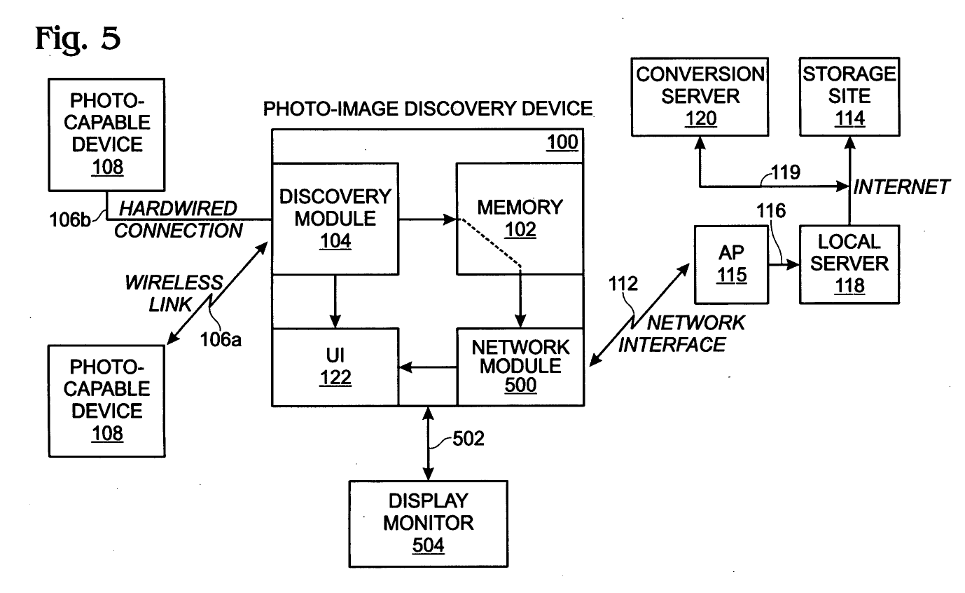

FIG. 5 is a schematic block diagram of a virtual photo-image reproduction kiosk. The virtual kiosk comprises a photo discovery device 100. In one aspect, the photo discovery device may include a few switched as LED indicators, hut the photo discovery 100 device has no dedicated display. The photo discovery device 100 includes a network module 500 for automatically uplinking photo-images to a network-connected storage site. This uplink function has been described above in the explanation of the uplink module. However, since the functions of the uplink module are expanded in this aspect, it is referred to as a network module in FIG. 5.

The network module 500 accesses the storage site 114 and downloads selected photo-images. Typically, the network module 500 uplinks and downloads photo-images from the storage site 114 using an IEEE 802.11 (WiFi) link. However, it would be possible to use other wireless formats. In a different aspect, the network module 500 receives a selected photo-image in a first photo-image file format (e.g. JPEG) and the UI module 122 converts the first photo-image file format to a second file image format (e.g., TIFF).

The user interface (UI) module 122 has an interface on line 502 for connection to a display monitor 504. The UI module 122 interfaces the photo discovery device to the display monitor 504 using an interface such as USB, high-definition multimedia interface (HDMI), or wireless. The display monitor 504 may be a television, PC, electronic picture frame, gaming platform, or cell phone to name a few examples. Some examples of wireless interfaces include Bluetooth and WiFi. The display monitor 504 is used to visually, and sometimes audibly, present a menu of photo-image user prompt, options. The prompt options are used, to select stored photo-images in response to the network module 500 accessing the storage site 114.

Generally, the network module 500 sends an inquiry to the storage site 114 requesting an inventory of stored photo-images and receives the inventory results. The UI module 114 presents the inventory results on the display monitor 504. In one aspect, the network module 500 accesses a storage site including a plurality of photo-Image folders. The UI module 122 presents the folders on the display monitor 504, and provides prompts for selecting a folder. Some examples of folders are presented, in the explanation of FIGS. 2 and 3. However, there are a number of ways of organizing photo-images into folders.

Subsequent to receiving the selected photo-images, the UI module 122 may receive prompts for transforming selected photo-Images, Some examples of image transformations include resizing, zooming, placement, cropping, rotation, resolution, compression, color editing, lightness editing, and red-eye removal. However, this is not an exhaustive list of every possible transformation. The UI module 122 can also be used to present a source profile menu for options on the display monitor 504. Some examples of sources include the photo-capable devices originating the photo-images that are uplinked to the storage site, and file formats.

In another aspect, the UI module 122 can be used to select delivery options for selected photo-images. That is, the network module 500 uplinks photo-images to the storage site 144 and accesses the storage site in response to prompts received by the UI module 122, and the UI module receives prompts for selecting a delivery option from a retailer associated with the first storage site. Then, the network module 500 sends selected delivery options to the storage site. More precisely, the UI module 122 receives input from a user operating the photo discovery device, and sends selection commands in response to the user input. For example, the UI module 122 may receive prompts for selecting a delivery media option such, as printed media, DVD, video tape, or SD memory card.

The various components and modules of the photo discovery device may be enabled using state machine and combinational logic circuitry. Alternately, portions of the device may be enabled using a software application of instructions that are stored in memory and executed by a processor. A photo discovery device processor with a software application stored in memory is shown in FIG. 4A.

### Functional Description

Conventionally, a user must perform many steps to store their pictures into a website for sharing, printing, or archiving. Further, a large proportion of these users either do not own a PC, or they are uncomfortable using a PC. These users would like to store, edit, print, and archive their pictures and video clips without having to go thru an intermediate step requiring the use of a PC.

To that end, the photo-image discovery device described in FIG. 1 automates the upload of files from devices such as a digital camera, 3G phones, and cell phone to a backend service by reducing/eliminating the user intervention. Reduced user intervention accelerates the availability of photo-images for sharing, viewing, protecting, and printing. Unlike conventional automatic acquisition technology, the photo-image discovery device disclosed herein is not limited to a single kind of image media, single image source, or single image destination.

The system described in FIG. 5 permits any monitor, including a TV screen, PC monitor, or digital picture frame to become a virtual kiosk for organizing pictures in a repository website or back end photo service center. The kiosk can be used to order prints and arrange delivery of those prints. The kiosk provides a home shopping experience without the bother of using a PC.

FIG. 6 is a diagram depicting the photo-image discovery device from a functional perspective. In one aspect, a digital camera or SD memory card is connected to the photo-image discovery device using a USB cable. The photo-image discovery device automatically transfers pictures, video clips, files to its memory/storage and asynchronously starts to upload those files, thru WiFi, to an archive backend service or picture website.

From a cell phone, a Bluetooth connection is established (pairing), and images acquired from the cell phone through the Bluetooth connection are uploaded to the backend service or the picture website. From a 3G phone, a WiFi connection is established with the photo-image discovery device and WiFi link is used to acquire pictures and video clips. A second WiFi link is used to transfer images from the photo-image discovery device to the backend service or picture website.

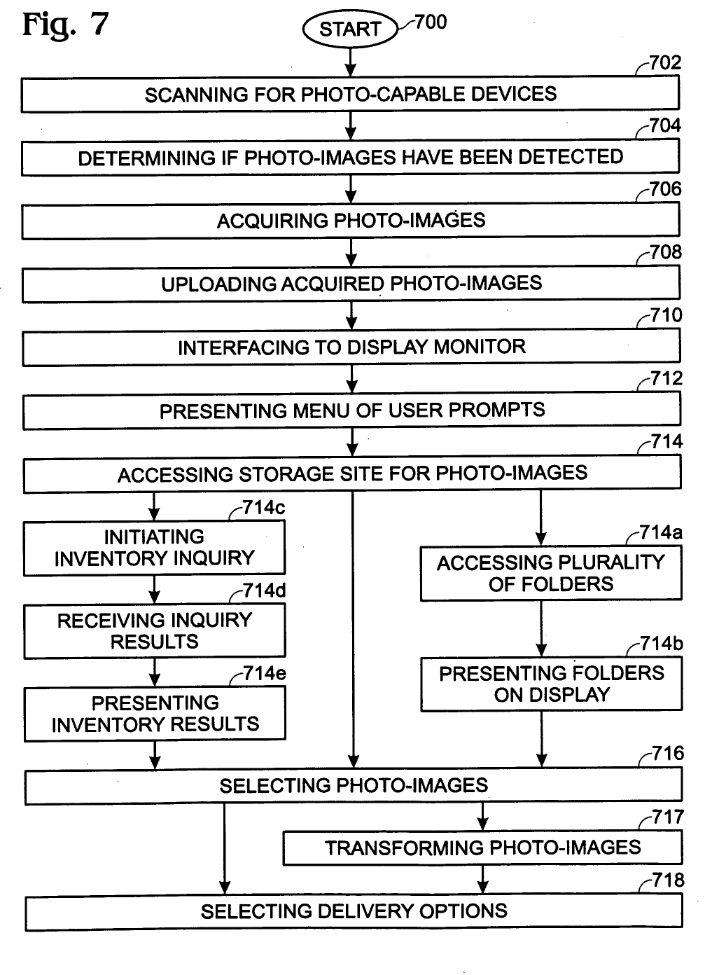

FIG. 7 is a flowchart illustrating a virtual kiosk method for stored photo-image reproduction. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 700.

In Step 702 a photo-image discovery device, having no dedicated display, scans communication interfaces for photo-capable devices. Step 704 determines if detected photo-capable devices have stored electronically formatted photo-images. Step 706 acquires the photo-images into the photo-image discovery device. Step 708 uploads the acquired photo-images to a network-connected storage site. Step 710 interfaces the photo discovery device to a display monitor. Some example interfaces include USB, HDMI, and any type of wireless protocol.

Step 712 presents a menu of photo-image user prompt, options on the display monitor, originating from the photo discovery device. In response to a first user prompt. Step 714 accesses the storage site from the photo discovery device, for example, via a WiFi link. In response to a second user prompt, Step 718 selects a stored photo-image.

In one aspect, accessing the network-connected storage site from the photo discovery device in Step 714 includes substeps. Step 714a accesses a storage site including a plurality of photo-image folders. In Step 714b, the photo discovery device presents the folders on the display monitor. Then, selecting stored photo-image in Step 716 includes selecting a folder in response to a user prompt. In one aspect, subsequent to selecting the stored photo-images in Step 716, Step 717 accepts user prompts for transforming the photo-image. Some examples of image transformations include resizing, zooming, placement, cropping, rotation, resolution, compression, color editing, lightness editing, and red-eye removal.

In another aspect, Step 718 selects a delivery option for the selected photo-image in response to a third user prompt. For example. Step 718 may select a media option such as printed medium pictures, DVD, video tape, and SD memory card, in one aspect. Step 708 uploads the photo-images to a first storage site, Step 714 accesses the first storage site, and Step 718 receives delivery of the photo-images from a retailer associated with the first storage site.

In another aspect, accessing the network-connected storage site from the photo discovery device in Step 714 includes alternate substeps. In Step 714c the photo discovery device initiates an inquiry to the storage site requesting an inventory of stored photo-images. In Step 714d the photo discovery device receives the inventory results, and in Step 714e the photo discovery device presents the inventory results on the display.

In one aspect, receiving the inventory results in Step 714d includes receiving a photo-image in a first photo-image file format. Then, presenting the inventory results on the display in Step 714e includes converting the first photo-image file format to a second file image format.

In another aspect, presenting the menu of photo-image user prompt options on the display in Step 712 includes presenting a source profile menu for options such as the photo-capable devices originating the photo-images transferred to the storage site, or file formats.

A system and method have been provided for virtual kiosk photo-image reproduction. Examples of specific processes and hardware modules have been given to illustrate the invention. However, the invention is not limited to merely these examples. Other variations and embodiments of the invention will occur to those skilled in the art.

We claim:

1. A virtual kiosk method for stored photo-image reproduction, the method comprising:
a photo-image discovery device, having no dedicated display, scanning communication interfaces for photo-capable devices;
determining if detected photo-capable devices have stored electronically formatted photo-images;
acquiring the photo-images into the photo-image discovery device;
uploading the acquired photo-images to a network-connected storage site;
interfacing the photo discovery device to a display monitor;
presenting a menu of photo-image user prompt options on the display monitor, originating from the photo discovery device;
in response to a first user prompt, accessing the storage site from the photo discovery device; and,
in response to a second user prompt, selecting a stored photo-image.

2. The method of claim 1 wherein accessing the network-connected storage site from the photo discovery device includes:
accessing a storage site including a plurality of photo-image folders;
the photo discovery device presenting the folders on the display monitor;
wherein selecting stored photo-image includes selecting a folder in response to a user prompt.

3. The method of claim 1 further comprising:
in response to a third user prompt, selecting a delivery option for the selected photo-image.

4. The method of claim 3 wherein selecting the delivery option for the selected photo-image includes selecting a media option from a group consisting of printed medium pictures, DVD, video tape, and secure digital (SD) memory card.

5. The method of claim 3 wherein transferring the photo-images to the storage site includes transferring the photo-images to a first storage site;
wherein accessing the network-connected storage site from the photo discovery device includes accessing the first storage site; and,
wherein selecting the delivery option for the selected photo-image includes receiving delivery from a retailer associated with the first storage site.

6. The method of claim 1 wherein accessing the network-connected storage site from the photo discovery device includes establishing an IEEE 802.11 (WiFi) link between the photo discovery device and the storage site.

7. The method of claim 1 wherein accessing the network-connected storage site from the photo discovery device includes:
the photo discovery device initiating an inquiry to the storage site requesting an inventory of stored photo-images;
the photo discovery device receiving the inventory results; and,
the photo discovery device presenting the inventory results on the display monitor.

8. The method of claim 7 wherein receiving the inventory results includes receiving a photo-image in a first photo-image file format; and,
wherein presenting the inventory results on the display monitor includes converting the first photo-image file format to a second file image format.

9. The method of claim 1 further comprising:
subsequent to selecting the stored photo-images, accepting user prompts for transforming the photo-image selected from a group consisting of resizing, zooming, placement, cropping, rotation, resolution, compression, color editing, lightness editing, and red-eye removal.

10. The method of claim 1 wherein presenting the menu of photo-image user prompt options on the display monitor includes presenting a source profile menu for options selected from a group consisting of photo-capable devices originating the photo-images transferred to the storage site, and file formats.

11. The method of claim 1 wherein interfacing the photo discovery device to the display monitor includes using an interface selected from a group consisting of USB, HDMI, and wireless.

12. A virtual photo-image reproduction kiosk comprising:
a photo discovery device having no dedicated display including:
a network module for automatically uplinking photo-images to a network-connected storage site, accessing the storage site, and downloading selected photo-images; and,
a user interface (UI) module having an interface for connection to a display monitor for presenting a menu of photo-image user prompt options, the prompt options selecting stored photo-images in response to the network module accessing the storage site.

13. The virtual kiosk of claim 12 wherein the network module accesses a storage site including a plurality of photo-image folders; and,
wherein the UI module presents the folders on the display monitor and provides prompts for selecting a folder.

14. The virtual kiosk of claim 12 wherein the UI module selects a delivery option for selected photo-images; and,
wherein the network module sends selected delivery options to the storage site.

15. The virtual kiosk of claim 14 wherein the UI module receives prompts for selecting a delivery media option from a group consisting of printed medium pictures, DVD, video tape, and secure digital (SD) memory card.

16. The virtual kiosk of claim 14 wherein the network module automatically uplinks photo-images to a first storage site and accesses the first storage site in response to prompts received by the UI module; and,
wherein the UI module receives prompts for selecting a delivery option from a retailer associated with the first storage site.

17. The virtual kiosk of claim 12 wherein the network module uplinks and downloads photo-images from the storage site using an IEEE 802.11 (WiFi) link.

18. The virtual kiosk of claim 12 wherein the network module sends an inquiry to the storage site requesting an inventory of stored photo-images and receives the inventory results; and,
wherein the UI module presents the inventory results on the display monitor.

19. The virtual kiosk of claim 18 wherein the network module receives a selected photo-image in a first photo-image file format; and,
wherein the UI module converts the first photo-image file format to a second file image format.

20. The virtual kiosk of claim 12 wherein the UI module, subsequent to receiving the selected photo-images, receives prompts for transforming the photo-image selected from a group consisting of resizing, zooming, placement, cropping, rotation, resolution, compression, color editing, lightness editing, and red-eye removal.

21. The virtual kiosk of claim 12 wherein the UI module presents a source profile menu for options selected from a group consisting of photo-capable devices originating the photo-images that are uplinked to the storage site and file formats.

22. The virtual kiosk of claim 12 wherein the UI module interfaces the photo discovery device to the display monitor using an interface selected from a group consisting of USB, HDMI, and wireless.
